(19) United States
(12) Patent Application Publication
(10) Pub. No.: US 2007/0276555 A1
(43) Pub. Date: Nov. 29, 2007

(54) Data integrity improvements of rail car identification process in localities having adjacent railway tracks

(75) Inventors: James M. Kiss, Melbourne, FL (US); John E. Borntraeger, Viera, FL (US); John W. Brand, Melbourne, FL (US)

Correspondence Address: BEUSSE WOLTER SANKS MORA & MAIRE, P.A., 390 NORTH ORANGE AVENUE, SUITE 2500, ORLANDO, FL, 32801, US

(73) Assignee: GENERAL ELECTRIC COMPANY

(21) Appl. No.: 11/441,718

(22) Filed: May 26, 2006

(51) Int. Cl. G06F 17/00

(52) U.S. Cl. 701/19; 246/122 R

(57) ABSTRACT

A system of identifying rolling stock within a rail yard when additional rolling stock may be present on an adjacent track, the system including identification markers attached on opposite sides of a rolling stock, an identification marker reader located proximate a track upon which the rolling is upon operable to communicate with the markers to gather information from the markers, a processor in communication with the identification marker readers, and an algorithm within the processor for using the information associated with the identification markers to determine a location of the rolling stock.

### FIELD OF INVENTION

This invention relates generally to the field of rail transportation and, more particularly, to improvements in identifying rail cars when cars may be located on adjacent tracks.

### BACKGROUND OF THE INVENTION

Rail yards are the hubs of railroad transportation systems. Therefore, rail yards perform many services, for example, freight origination, interchange and termination, locomotive storage and maintenance, assembly and inspection of new trains, servicing of trains running through the facility, inspection and maintenance of railcars, and railcar storage. The various services in a rail yard compete for resources such as personnel, equipment, and space in various facilities so that managing the entire rail yard efficiently is a complex operation.

One such service in the rail yard is a rail yard classification system. Yard classification systems are designed around knowing what cars are coming into a yard, where they are going, and to which tracks they should be sorted. Because this knowledge is quintessential to the function of managing rail yards, failures are induced when the cars do not appear as expected, or are misread, such as by a radio frequency identification (RFID) system. In particular, a car on an adjacent track may be read instead of the intended car. This situation can cause a misroute of cars and increase the amount of time it takes to sort cars.

The railroads in general recognize that yard management tasks would benefit from the use of management tools based on optimization principles. Such tools would use a current yard status and a list of tasks to be accomplished to determine an optimum order in which to accomplish these tasks.

However, any management system relies on credible and timely data concerning the present state of the system under management. In most rail yards, the current data entry technology is a mixture of manual and automated methods. For example, automated equipment identification (AEI) readers and AEI computers, using RFID technology, determine the location of rolling stock at points in the sequence of operations.

### BRIEF DESCRIPTION OF THE INVENTION

This invention is directed towards a method, computer program and system for improvements in identifying rail cars when cars may be located on adjacent tracks. Towards this end a system of identifying rolling stock within a rail yard when additional rolling stock may be present on an adjacent track is disclosed. The system comprises identification markers attached on opposite sides of a rolling stock. An identification marker reader is provided, proximate a track upon which the rolling stock is upon. The reader is operable to communicate with the markers to gather information from the markers. A processor in communication with the identification marker reader is also provided. An algorithm is included within the processor for using the information associated with the identification markers to determine a location of the rolling stock.

A computer software code for identifying and determining a position of rolling stock within a rail yard is also disclosed. The computer software code uses a system that includes at least two identification devices proximate opposite sides of the rolling stock, an identification reader proximate a first track upon which the rolling stock traverses, and that is in communication with the identification devices when the identification devices are proximate, and a processor. The computer software code comprises a computer software module for determining if rolling stock is proximate the identification reader, a computer software module for processing information received from the identification devices, and a computer software module for determining if the first track has rolling stock upon it. A computer software module for determining if a second track has rolling stock upon it is also provided. Additionally, a computer software module for verifying the track rolling stock on the first track is further included.

A method of identifying rolling stock within a rail yard using a system having an identification tag on the rolling stock and an identification tag reader proximate a first rail track is further disclosed. The method comprises determining whether rolling stock is proximate the identification tag reader. The method also comprises processing indicia from the tag, and determining whether rolling stock is proximate a second track. The method also verifies whether the rolling stock is on the first track.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts an exemplary schematic of a system for verifying validity of AEI tag reads in accordance with the present invention;

FIG. 2 depicts an exemplary flow chart of for verifying validity of AEI tag reads in accordance with the present invention;

FIG. 3 depicts an exemplary logic chart for when a manifest list is available; and

FIG. 4 depicts an exemplary logic chart for when no manifest list is available.

### DETAILED DESCRIPTION OF THE INVENTION

With reference to the figures, exemplary embodiments of the invention will now be described. However, it should be noted that though the present invention describes various embodiments, namely a method, computer program, and system, those skilled in the art will readily recognize that the invention can be implement where each embodiment may overlap. Towards this end, the exemplary embodiments discussed herein should not be viewed as individual embodiments but the intent of the elements of the present invention shall be used collectively as well wherein the method steps may be exchanged with computer software elements and/or with hardware elements.

Furthermore, though the present invention is discussed with respect to hump yards, the present invention may work with any type of rail yards. Towards this end and for clarification, hump yards are the largest and most effective classification yards for rail cars with the largest shunting capacity of several thousand cars a day. The heart of these yards is the hump, which is a track on a hill (hump) over which the rail cars are pushed by an engine, or locomotive, after being uncoupled just before or at the top (hump crest) and then they roll, either as single cars or some coupled cars together, by gravity into their destination tracks in the classification bowl (the tracks where the cars are sorted).

The hump yard process may be initiated with an establishment of a list of cars to be humped. The list is referred to as a hump list. Rail cars are then moved to a track, a hump lead, where they are to be coupled together to form a train. As disclosed herein, the hump yard process may also be initiated without a hump list.

Rail classification systems need to have reliable manifests to accomplish the tasks of sorting and forwarding rail cars. Most systems get these manifests from databases on a corporate network. After a train is built, a list of the cars in that train is uploaded to a database by yard personnel and/or automatic equipment identification (AEI) systems. This train will travel from one yard to the next, where the train is then divided into subsections that will be forwarded to their next respective yard. If this information is erroneous the trains may not, in reality, consist of what was placed into the database by the Automatic equipment Identification System. This results in misroutes of cars that cost the railroads the effort of rerouting the cars to the correct location.

An issue that has resulted from AEI technology used in rail yards is that in some cases when there are adjacent tracks 10, 15 and rail cars are traveling on the adjacent tracks, the AEI reader may inadvertently read the AEI tag on the rail cars on the adjacent track. This may result in identifying cars associated with a wrong track to a track where the AEI reader is monitoring.

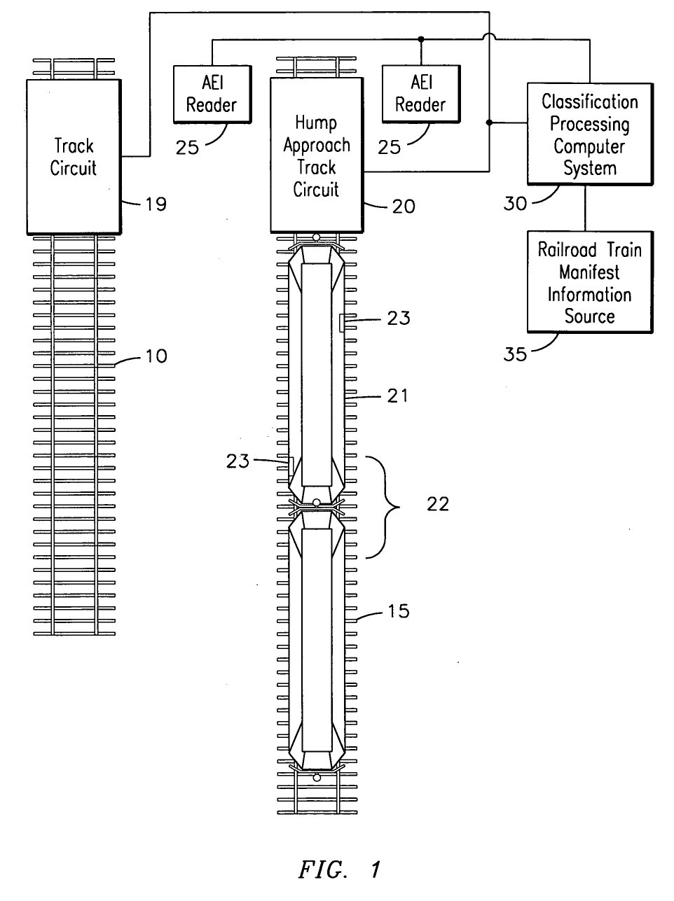

FIG. 1 depicts an exemplary embodiment of elements that may constitute the present invention. As illustrated, a detection device, such as, but not limited to, an automated equipment identification (AEI) reader 25 is positioned on opposite sides of a track. Each piece of rolling stock 21 in a train consist 22, for example each railcar 21, has an identification marker, or tag 23. In an exemplary embodiment, a marker 23 is located on opposite sides of the rolling stock 21. In addition to being on opposite sides, the markers are typically located at opposite ends of the rolling stock 21 as well. Even though at least two markers 23 are discussed herein, those skilled in the art will readily recognize that depending on the marker technology used, the present invention may function when only a single marker is used. In such a situation, the tag 23 will contain enough information to uniquely identify the rolling stock 21.

An exemplary example of the identification tag 23 is an Automated Equipment Identification (AEI) tag 23. The AEI tag 23 contains information, or indicia, that uniquely identifies a rolling stock 21. The information may include information as to a side of the rolling stock where the tag is located. As each piece of rolling stock 21 passes an identification tag reader, or antenna, 25, such as, but not limited to, an AEI reader 25, the reader 25 collects identification information from each AEI tag 23, thereby identifying each piece of rolling stock 21 that passes that reader 25. As illustrated an AEI reader 25 is located on opposite sides of a track 15 so as to read the markers 23 on each side of the car 21. Currently a trackside microprocessor is connected to two read antennas through a diplexer. The microprocessor is then connected to the through a controller to the processing computer 30. Those skilled in the art will readily recognize that a single reader 25 or more than two readers 25 may be utilized. For example, where a single reader may be used, passive reader technology may be utilized. The reader 25 may be positioned proximate the track 15 so as to read tags 23 on both sides of a rolling stock 21.

In an exemplary embodiment, the AEI tag 23 contains coded information and the AEI reader 25 is a backscatter transponder. However, the AEI tag 23 and the AEI reader 25, are not limited to utilizing backscatter technology, and any other information recording and tracking equipment is applicable, for example, a tag containing printed information and a reader using optical character recognition technology. Such other technology may include, but is not limited to radio frequency identification (RFID) technology.

Also provided in the present invention is a hump approach track circuit 20. The hump approach circuit notifies the AEI reader 25 that cars 21, with tags 23 to be read, are on the track 15 in front of and/or approaching the tag reader 25. On an adjacent track 10 a track circuit 19 is provided. The track circuit 19 notifies the present invention when the adjacent track 10 is occupied. A classification processing processor 30, or computer system, in communication with the AEI readers and hump approach track circuit, is also provided. A railroad train manifest information source, such as a database 35, is in communication with the computer system.

Data collected from rail cars by the AEI readers 25 is provided to the classification processing computer 30. The processing computer 30 may also include an electronic storage device for storing programs, information and data. The processing computer also may provide a display for viewing information, data, and graphical representation of the rail yard. Such information may also include video displays of rail cars. A dispatcher interface may also be included to allow an operator to input information and data into the processing computer.

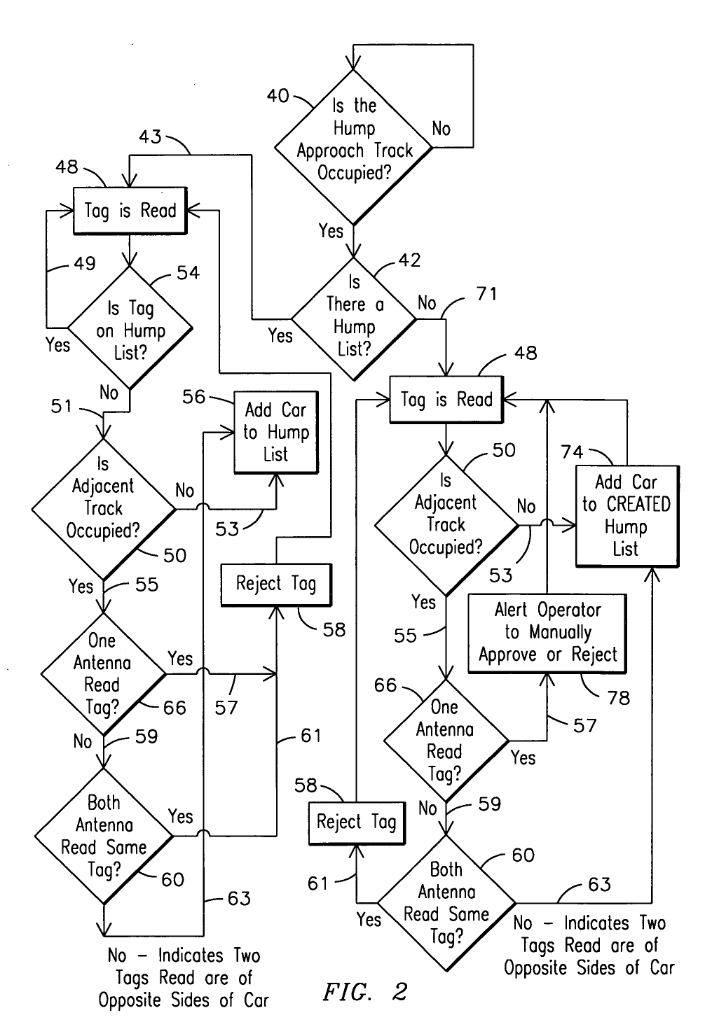

FIG. 2 depicts a flow chart for verifying validity of AEI tag reads in accordance with the present invention. Classification begins by determining whether a car is on the approach side of the hump crest, step 40. When classification begins, step 40, a determination is made as to whether there is a manifest, step 42. The AEI tag 23 is then read, step 48. If on the list, step 49, this information is logged and the present invention continues to read other tags 23. If the tag 23 is not on the list, step 51, a determination is then made as to whether the adjacent track is occupied, step 50. This is accomplished using the track circuit 19 of the adjacent track 10 to determine track activity. If nothing is detected, step 53, information regarding the car 21 is added to the hump list, step 56.

When the adjacent approach is occupied, step 55, a determination is made whether only one reader 25 detects the tag 23, step 66. If only one reader 25 along a track 15 reads a tag 23 on a car 21, step 57, the decision is that this car 21 is on the adjacent track 10 and the tag is rejected, step 58.

If both tags read a tag, step 59, a determination is then made regarding whether the readers 25 are reading the same tag 23. Specifically, each tag identifies its self as not only the car it is associated with, but on which side of the car the tag is attached. Thus a determination is made regarding whether both antennas read the same tag, step 60. If both readers 25 each read a tag 23 with the same serial number and the location of the tags 23 are identified as being on the same side of the car 21, step 61, yet each reader is on opposite sides of a track, the tag is rejected, step 58. However, if the readers 25 identify two tags 23 where the serial numbers are the same and the identification of the tags are for opposite sides of the car 21, step 63, the car 21 information is added to the hump list, step 56.

When determining whether there is a manifest, step 42 and no manifest exists, step 71, the present invention reads tags 23 detected, step 48. A determination is made as to whether the adjacent track is occupied, step 50. If the adjacent track 10, is not occupied, step 53, the information pertaining to the specific rolling stock 23 is added to create a hump list, step 74. If the adjacent track is occupied, sep 55, a determination is made as to whether the rolling stock 23 is detected by only one antenna, step 66. As discussed above, if it is, step 57, the operator is alerted so as to either manually approve or reject adding this rolling stock 23 to the hump list. If the readers 25 on the opposite sides of the track read the identical tag 23, as discussed in more detail above, the tag 23 is rejected, step 58. If the antennas do not read the same tag, step 63, the rolling stock 21 is added to the hump list, step 74.

In an exemplary embodiment, the present invention is software-based logic. Based on the foregoing specification, the methods described above may be implemented using computer programming or engineering techniques including computer software, firmware, hardware or any combination or subset thereof, wherein the technical effect is to provide an improvement for identifying rail cars when rail cars are on adjacent tracks. Any such resulting program, having computer-readable code means, may be embodied or provided within one or more computer-readable media, thereby making a computer program product, i.e., and an article of manufacture, according to the invention. For example, as disclosed herein, the computer readable media may include a computer program code for determining whether rolling stock is proximate the identification tag readers. Additional code may include code for processing tag indicia from the tags, determining whether rolling stock is proximate a second track, and verifying whether the rolling stock is on the first track.

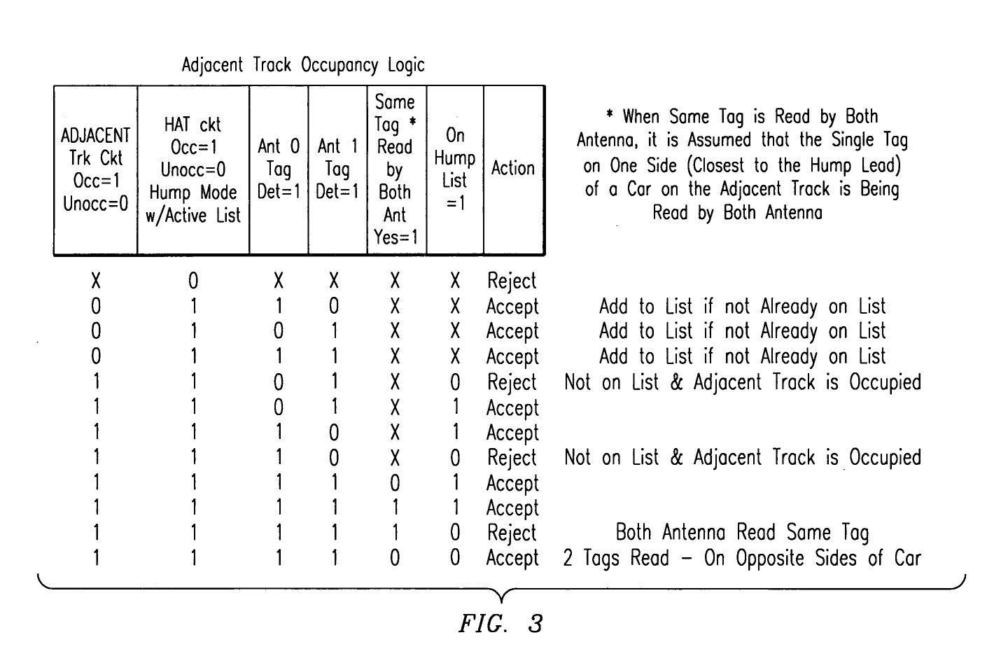

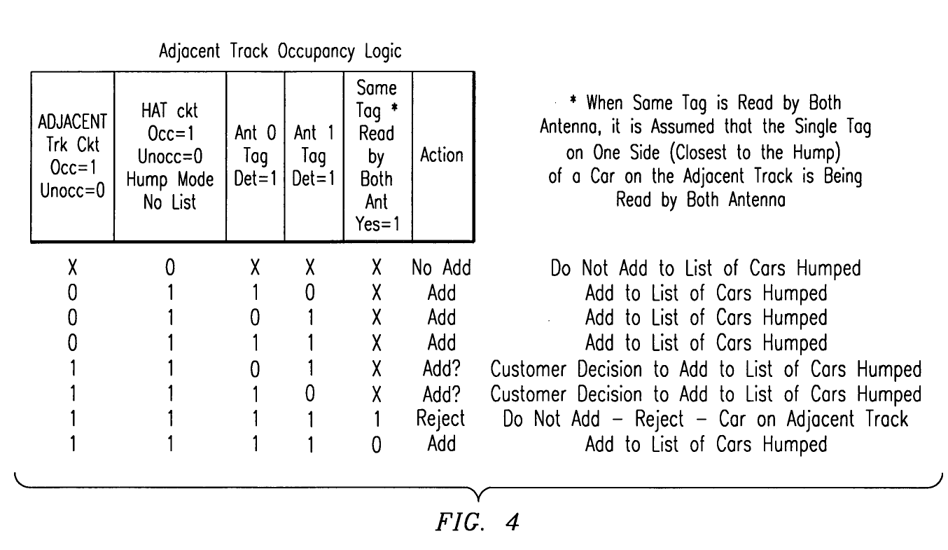

Towards this end, adjacent track occupancy logic charts are shown. FIG. 3 depicts an exemplary logic spreadsheet, or chart, for when a manifest list is available, whereas FIG. 4 depicts an exemplary logic spreadsheet, or chart, for when no manifest list is available. Each chart illustrates the logic used when reading tags 23 and when to accept 81 or reject 83 rolling stock 21 on a manifest list, and when to add 85 to a manifest list. Both logic charts take into consideration whether rolling stock 21 is on an adjacent track, and when a track is occupied, and what each reader 25 is detecting.

The computer readable media may be, for example, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will be able to combine the software created as described with appropriate general purpose or special purpose computer hardware, such as a microprocessor, to create a computer system or computer sub-system embodying the method of the invention. An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention.

While the invention has been described in what is presently considered to be a preferred embodiment, many variations and modifications will become apparent to those skilled in the art. Accordingly, it is intended that the invention not be limited to the specific illustrative embodiment but be interpreted within the full spirit and scope of the appended claims.

What is claimed is:

1. A system of identifying rolling stock within a rail yard when additional rolling stock may be present on an adjacent track, the system comprising:
a) identification markers attached on opposite sides of a rolling stock;
b) an identification marker reader located proximate a track upon which the rolling is upon operable to communicate with the markers to gather information from the markers;
c) a processor in communication with the identification marker reader; and
d) an algorithm within the processor for using the information associated with the identification markers to determine a location of the rolling stock.

2. The system of claim 1 further comprises a manifest list accessible by the algorithm.

3. The system of claim 1 further comprises a detection device that activates the readers when rolling stock is approaching the readers.

4. The system of claim 1 wherein the rolling stock is identified by at least two identification markers each on opposite sides of the track wherein rolling stock on an adjacent track that may be identified by a reader closest to the track is not identified by the reader on an opposite side of the track.

5. The system of claim 1 wherein the processor further comprises at least one of a visual interface and input device for a user.

6. The system of claim 1 wherein the identification markers and identification marker readers communicate wirelessly.

7. The system of claim 6 wherein the identification markers and identification marker readers communicate using radio frequency identification technology.

8. The system of claim 6 wherein the identification marker is a backscatter transponder.

9. They system of claim 1 further comprises a data storage device for retention of at least one of information collected and results of identifying rolling stock.

10. A computer software code for identifying and determining a position of rolling stock within a rail yard using a system that includes at least two identification devices proximate opposite sides of the rolling stock, an identification reader proximate a first track upon which the rolling stock traverses that is in communication with the identification devices when the identification devices are proximate, and a processor, the computer software code comprising:
a) a computer software module for determining if rolling stock is proximate the identification readers;
b) a computer software module for processing information received from the identification devices;
c) a computer software module for determining if the first track has rolling stock upon it;
d) a computer software module for determining if a second track has rolling stock upon it; and
e) a computer software module for verifying the track rolling stock is on the first track.

11. The computer software code of claim 10 further comprises a computer software module for notifying a user when information received from a first identification device does not agree with information received from a second identification device.

12. The computer software code of claim 10 further comprises a computer software module for creating a manifest list based on information received from the identification devices.

13. The computer software code of claim 10 further comprises providing a manifest list.

14. The computer software code of claim 13 further comprises a computer software module for verifying information received from the identification devices to information contained on the manifest list.

15. A method of identifying rolling stock within a rail yard using a system having an identification tag on the rolling stock and an identification tag reader proximate a first rail track, the method comprising:
a) determining whether rolling stock is proximate the identification tag readers;
b) processing tag indicia from the tags;
c) determining whether rolling stock is proximate a second track; and
d) verifying whether the rolling stock is on the first track.

16. The method of claim 15 further comprising notifying a user when indicia received from a first identification device does not agree with indicia received from a second identification device.

17. The method of claim 15 further comprises creating a manifest list for a train consist based on indicia received from the identification tags.

18. The method of claim 15 further comprises providing a manifest list.

19. The computer software code of claim 18 further comprises verifying indicia received from the identification tags to indicia contained on the manifest list.
